(19) United States
(12) Patent Application Publication
(10) Pub. No.: US 2004/0108039 A1
(43) Pub. Date: Jun. 10, 2004

(54) Process of making ribbons

(76) Inventor: Fernando Antonio Suzigan, Americana (BR)

Correspondence Address: SHAPIRO COHEN, P.O. BOX 3440, STATION D, OTTAWA, ON, K1P6P1, CA

(21) Appl. No.: 10/359,269

(22) Filed: Feb. 6, 2003

(30) Foreign Application Priority Data
Dec. 6, 2002 (BR) 005841

(51) Int. Cl. B32B 31/16

(52) U.S. Cl. 156/73.1; 156/73.2; 156/251

(57) ABSTRACT

A process of making ribbons which is carried out in a special machine that emits ultrasound, where the cloths, non-woven cloths, or any synthetic based surface accepting ultrasound welding, are cut in ribbons while markings are simultaneously applied to the ribbons' edge. The process of cutting cloths in strips (ribbons) and the process of marking the edges of the strips are done simultaneously on an ultrasound bar by a tool comprising a circular cutting knife, and by a rotating matrix heads with the desired marking drawings. If wire strings covered with synthetic textile substratum are to be applied to the ribbons, they are longitudinally applied along the mentioned ribbons by ultrasound welding and/or gluing process. These processes are carried out simultaneously to the cutting and marking processes of the ribbons, all happening in a single operation.

### BACKGROUND OF THE INVENTION

1. Field of the Invention

The present invention relates to processes of making ribbons.

2. Description of the Prior Art

The present invention provides an innovative and economic process of making ribbons for several different purposes, in substitution to the conventional process of making ribbons in loom, including cutting or marking steps and/or application of monofilament or multifilament wire covered with synthetic textile substratum. The process provides a series of technical, practical and functional advantages, resulting in a better-finished final product, and consequently in a more economic way the ribbons are woven in loom.

Ribbons present in cloths, non-woven cloths, or with any synthetic based substratum, which accept ultrasound welding, are used for several different purposes, such as: handicrafts, decorations, ornamentation, presents, etc., contributing in order that the products and the purposes to the use of those ribbons highlight greatly in all the circumstances.

### SUMMARY OF TUE INVENTION

In the present invention, ribbons are obtained by cutting cloths in strips. In order to have ribbons with edges of a better quality finishing, markings with permanent deformation of the substratum, and/or application of monofilament of multifilament wires, have been used. Edges of a better quality finishing enable ribbons woven to be perfectly reproduced through the conventional process keeping them ribbons and their edges free from unwanted residues resulting from the conventional hot cutting process.

Markings or application of mono or multifilament wires are obtained through the process claimed in the present invention simultaneously to the cloths cutting process by the ultrasound system, using rotating matrix heads for the markings, and devices specially created for the application. The present process enables mono or multifilament wires, covered with synthetic textile substratum, to be applied along the edges and/or in any part of the substratum. This application can be done both by the ultrasound process and the gluing process, and also on the ribbons woven in loom through the conventional process.

### BRIEF DESCRIPTION OF THE DRAWINGS

FIG. 1 is a plan including the cloth cutting process, the process of applying markings to the edges of the ribbons cut, and the application of mono or multifilament wires covered with synthetic textile substratum to the ribbons, through an ultrasound welding process or a gluing process.

FIG. 2 is a piece of ribbon with markings applied to its edges.

FIG. 3 is a piece of ribbon including the mono/multifilament wires, covered with synthetic textile substratum, applied by ultrasound welding.

### DETAILED DESCRIPTION OF THE INVENTION

The invention will be described for the purposes of illustration only in connection with certain embodiments; however, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

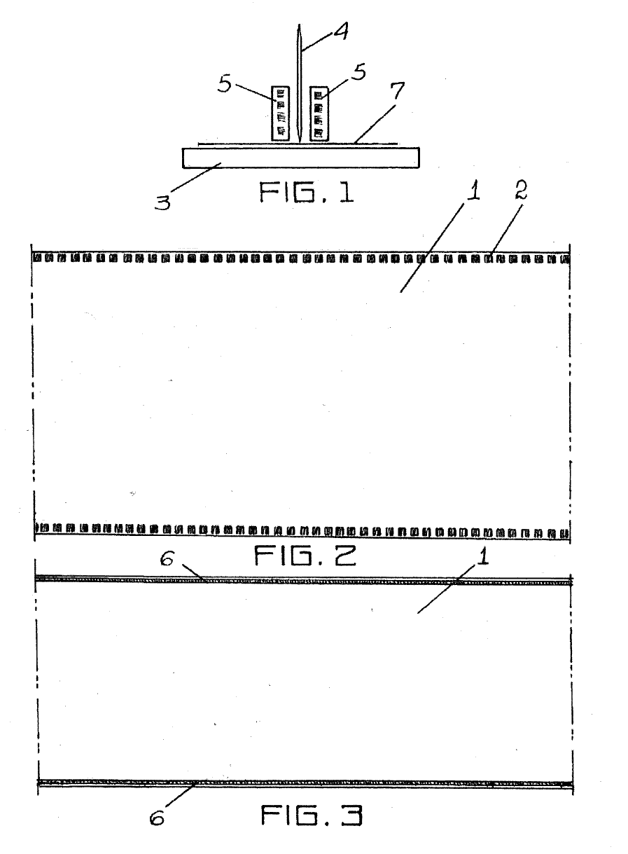

FIGS. 1, 2 and 3 show the process of making ribbons proposed herein, where the cloth (7), non-woven cloths or any synthetic based surface accepting ultrasound welding, are cut in strips (ribbons) while markings are simultaneously applied to the strips' edges. These operations are carried out in a special machine emitting ultrasound, not claimed in the present invention.

The process of cutting cloths in strips (ribbons) (1) and the process of marking (2) the edges of the strips are done simultaneously on an ultrasound bar (3) by a tool comprising a circular cutting knife (4), and by a rotating matrix heads (5) with the desired marking drawings.

If wire strings covered with synthetic textile substratum (6) are applied to the ribbons, they are longitudinally applied along the mentioned ribbons by ultrasound welding and/or gluing process. These processes are carried out simultaneously to the cutting and marking processes of the ribbons, all happening in a single operation.

Thus, the present process of making ribbons for different purposes involving cutting and marking steps and/or application of monofilament or multifilament wires covered with synthetic textile substratum completely reaches the proposed targets. The process practically and efficiently carries out the functions to which it has been conceived, providing a series of inherent advantages to its technical, practical and functional applicability. These advantages are mainly related to cost reduction, having its own innovative characteristics endowed with fundamental requirements of novelty.

It should be understood that the preferred embodiments mentioned here are merely illustrative of the present invention. Numerous variations in design and use of the present invention may be contemplated in view of the following claims without straying from the intended scope and field of the invention herein disclosed.

Having thus described the invention, what is claimed as new and secured by Letters Patent is:

1. A process of making ribbons carried out in a machine emitting ultrasound, said process comprising the steps of:
cutting cloth into ribbon; and
applying markings to edges of said ribbon.

2. The process according to claim 1, wherein said cloth is formed from non-woven material and accepts ultrasound welding.

3. The process according to claim 1, wherein said cloth is formed from synthetic-based material and accepts ultrasound welding.

4. The process according to claim 1, wherein said step of cutting said cloth and said step of marking said edges are performed simultaneously on an ultrasound bar by a tool including a circular cutting knife and rotating matrix heads for making desired marking drawings, respectively.

5. The process according to claim 1, further comprising an additional step of applying a monofilament wire string covered with synthetic textile substratum to said ribbon, wherein said step of cutting said cloth and said step of marking said edges are performed simultaneously with said additional step.

6. The process according to claim 1, further comprising an additional step of applying a multifilament wire string covered with synthetic textile substratum to said ribbon, wherein said step of cutting said cloth and said step of marking said edges are performed simultaneously with said additional step.

7. The process according to claim 1, wherein said additional step is performed by ultrasound welding.

8. The process according to claim 1, wherein said additional step is performed by gluing.

9. The process according to claim 1, wherein said additional step is performed by a combination of ultrasound welding and gluing.

10. A process of making ribbons carried out in an ultrasound bar tool, said process comprising the steps of:
cutting cloth into ribbon by means of a circular cutting knife of said ultrasound bar tool;
simultaneously applying markings to edges of said ribbon by means of rotating matrix heads of said ultrasound bar tool; and
simultaneously applying a wire string covered with a synthetic textile substratum to said ribbon.

11. The process according to claim 10, wherein said cloth is formed from non-woven material and accepts ultrasound welding.

12. The process according to claim 10, wherein said cloth is formed from synthetic-based material and accepts ultrasound welding.

13. The process according to claim 10, wherein said wire string is monofilament wire.

14. The process according to claim 10, wherein said wire string is multifilament wire.

15. The process according to claim 10, wherein said step of applying said wire string covered with said synthetic textile substratum to said ribbon is performed by ultrasound welding.

16. The process according to claim 10, wherein said step of applying said wire string covered with said synthetic textile substratum to said ribbon is performed by gluing.

17. The process according to claim 10, wherein said step of applying said wire string covered with said synthetic textile substratum to said ribbon is performed by a combination of ultrasound welding and gluing.
